(19) United States
(12) Patent Application Publication
(10) Pub. No.: US 2024/0202175 A1
(43) Pub. Date: Jun. 20, 2024

(54) ROBOT CONTROL DEVICE AND ROBOT CONTROL SYSTEM

(71) Applicant: FANUC CORPORATION, Yamanashi (JP)

(72) Inventor: Akihiro YANAGITA, Yamanashi (JP)

(73) Assignee: FANUC CORPORATION, Yamanashi (JP)

(21) Appl. No.: 18/557,251

(22) PCT Filed: May 26, 2021
(86) PCT No.: PCT/JP2021/020072

§ 371 Date: Oct. 25, 2023

(51) Int. Cl. G06F 16/22; G08B 21/18

(52) U.S. Cl. CPC G06F 16/22; G08B 21/182

(57) ABSTRACT

A robot control system that offers a great degree of freedom for processing to be performed when an alarm is generated is a robot control device for controlling a robot, and comprises: a database storage unit capable of storing a plurality of alarm attribute information databases which store a plurality of pieces of alarm attribute information, respectively; a database addition processing unit for adding the alarm attribute information database to the database storage unit in accordance with an input of a user; and an alarm processing unit for generating an alarm on the basis of the alarm attribute information.

### TECHNICAL FIELD

The present invention relates to a robot control device and a robot control system.

### BACKGROUND ART

A robot control device for controlling a robot is configured to generate an alarm when an abnormality of the robot or peripheral equipment is detected during the operation of the robot, and perform predetermined processing such as stopping the robot, issuing an alert, and displaying a message. Furthermore, the robot control device may be configured such that a user program created by a user can specify what alarm is generated in what case (e.g., see Patent Document 1).
Patent Document 1: Japanese Unexamined Patent Application, Publication No. H2-243290

### DISCLOSURE OF THE INVENTION

### Problems to be Solved by the Invention

In the robot control device disclosed in Patent Document 1, a user alarm instruction including an alarm number and a display message is included in the user program. However, the alarm instruction in the user program alone cannot describe, for example, complicated processing that causes the robot to perform a predetermined operation at the time of alarm generation or alarm recovery. Therefore, a technology capable of increasing the degree of freedom of processing to be specified when an alarm is generated is awaited.

### Means for Solving the Problems

A robot control device according to an aspect of the present disclosure is a robot control device for controlling a robot. The robot control device includes a database storage unit configured to store a plurality of alarm attribute information databases each storing a plurality of pieces of alarm attribute information, a database addition processing unit configured to add an alarm attribute information database to the database storage unit according to an input by a user, and an alarm processing unit configured to generate an alarm based on the alarm attribute information.

A robot control system according to an aspect of the present disclosure includes a robot control device for controlling a robot, and a management device for managing the robot control device. A database storage unit configured to store a plurality of alarm attribute information databases each storing a plurality of pieces of alarm attribute information, a database addition processing unit configured to add an alarm attribute information database to the database storage unit according to an input by a user, and an alarm processing unit configured to generate an alarm based on the alarm attribute information are each provided in at least one of the robot control device or the management device.

### Effects of the Invention

According to a robot control device and a robot control system according to an aspect of the present disclosure, the degree of freedom of processing when an alarm is generated is large.

### BRIEF DESCRIPTION OF THE DRAWINGS

FIG. 1 is a block diagram showing a configuration of a robot control device according to a first embodiment of the present disclosure; and

FIG. 2 is a block diagram showing a configuration of a robot control system according to a second embodiment of the present disclosure.

### PREFERRED MODE FOR CARRYING OUT THE INVENTION

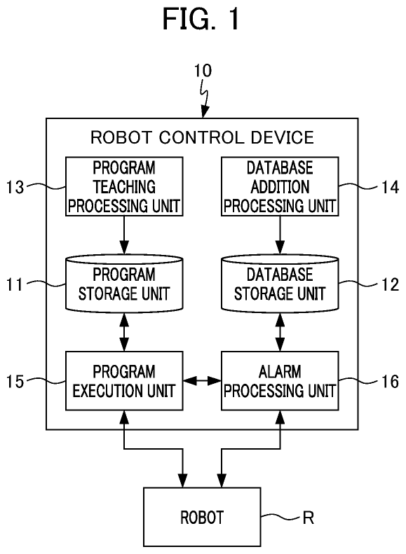

Hereinafter, embodiments of the present disclosure will be described with reference to the drawings. FIG. 1 is a block diagram showing a configuration of a robot control device 10 according to a first embodiment of the present disclosure.

The robot control device 10 controls a robot R according to a user program. The robot control device 10 can be implemented by causing a computer device including a memory, a processor (CPU), an input/output interface, and the like to execute an appropriate control program. The robot control device 10 may include an input device (a keyboard, a touch pad, or the like) and a display device (a display panel or the like), and may be connected to an external input device and display device. An example of an integrated input device and display device connected to the robot control device 10 is a teaching operation panel used for teaching the operation of the robot R.

The robot control device 10 includes a program storage unit 11, a database storage unit 12, a program teaching processing unit 13, a database addition processing unit 14, a program execution unit 15, and an alarm processing unit 16. These components are ones that fall under categorized functions of the robot control device 10, and do not need to be clearly distinguishable in terms of physical configuration or program configuration. The robot control device 10 may include still other components.

The program storage unit 11 stores a user program in which operations to be taught to the robot R are included. More specifically, the program storage unit 11 secures a storage area of a memory of the computer device, and controls writing and reading of a user program into and from the storage area.

The user program may include not only an instruction for specifying an operation of the robot R but also an instruction for specifying an operation of peripheral equipment such as a working head attached to the tip of the robot, and an alarm call instruction for specifying an alarm generation condition and alarm processing.

The database storage unit 12 stores a plurality of alarm attribute information databases each storing a plurality of pieces of alarm attribute information. Similarly to the program storage unit 11, the database storage unit 12 secures a storage area of the memory of the computer device, and controls writing and reading of an alarm attribute information database into and from the storage area. The database storage unit 12 only needs to be configured to store a plurality of alarm attribute information databases, and does not need to actually store a plurality of alarm attribute information databases.

Each piece of alarm attribute information is one record of the alarm attribute information database, and information identifying an event to be executed in one alarm processing is the content of each data item. The alarm attribute information database may be recorded as one file. As described above, by describing the contents of the alarm processing in one record, the contents of the alarm processing to be performed can be specified only by identifying the record, so that various alarm processing can be appropriately performed without creating a redundant user program.

The database storage unit 12 stores a plurality of alarm attribute information databases. The alarm attribute information database may include records of alarm processing having some common point, for example, records of alarm processing necessary for each part or equipment causing an alarm. This allows a large number of records to be managed in a hierarchical manner, making it easier to store and specify records, and preventing the number of fields in the alarm attribute information database from increasing and making its capacity unnecessarily large.

The alarm attribute information includes at least one of display text, alarm severity, alarm generated case processing procedure, or alarm recovered case processing procedure. That is, the alarm attribute information database includes at least one of a field of display text, a field of alarm severity, a field of alarm generated case processing procedure, or a field of alarm recovered case processing procedure. Thus, the contents of the alarm processing can be specifically identified.

The alarm attribute information may include a plurality of display texts corresponding to different languages. That is, the alarm attribute information database may include a plurality of fields corresponding to different languages in order to register a display text in the different languages. This facilitates multilingual handling. The field for recording the display text in a desired language may be specified in the alarm call instruction statement specifying the alarm processing. However, it is preferable to specify the field by a method such as the initial setting of the robot control device 10, specifying in the header of the user program, or setting by a switching operation with a teaching operation panel or the like connected to the robot control device 10, from the viewpoint of simplification of the user program and suppression of creation errors thereof.

The program teaching processing unit 13 creates a user program according to an input from a teaching operation panel or the like, and transfers the created user program to the program storage unit 11. Alternatively, the program teaching processing unit 13 may transfer all or a part of a pre-created user program input from the outside to the program storage unit 11 as is.

The user program may include a condition setting statement for setting one or more alarm generation conditions, and an alarm call instruction statement for specifying alarm attribute information for identifying alarm processing to be executed when each alarm generation condition is satisfied. To identify the alarm attribute information, the alarm call instruction statement can specify, as arguments, the number or file name of the alarm attribute information database, the number or unique key (e.g., an ID) of the alarm attribute information (record), and as necessary, a character string to be added to the display text and displayed.

For example, when the alarm call instruction is “alarm_post”, and as arguments, the number of the alarm attribute information database is “DatabaseID”, the number of the alarm attribute information is “AlarmNumber”, and the character string to be added to the display text and displayed is “Param_str”, the alarm call instruction statement is included as “alarm_post[DatabaseID, AlarmNumber, Param_str]”. When an alarm generation condition is detected during execution of the user program by using this instruction, a branch is executed and the alarm call instruction statement is executed without performing normal processing to generate an alarm, thereby alerting the operator and interrupting execution of the program. Such a user program can be created.

The database addition processing unit 14 adds an alarm attribute information database to the database storage unit 12 according to an input by the user. The database addition processing unit 14 may have a function of creating an alarm attribute information database according to an input by the user, or may read an alarm attribute information database created by another computer device or the like and transfer it to the database storage unit 12. The database addition processing unit 14 may provide user interfaces that allow the user to use an output device to assist in the creation of the alarm attribute information database, check the alarm attribute information database stored in the database storage unit 12, etc.

The database addition processing unit 14 is preferably configured to be able to add a new alarm attribute information database or to add new alarm attribute information to an existing alarm attribute information database as long as the storage capacity secured by the database storage unit 12 allows. Thus, when a specification of a facility including the robot R, such as a machining system or a handling system, or a workpiece or the like handled in the facility is changed, a new alarm attribute information database or new alarm attribute information is added, and the added alarm attribute information is used to use an alarm call instruction statement for generating an alarm, whereby an appropriate user program can be easily created.

The program execution unit 15 controls the robot R or the like according to a user program stored in the program storage unit 11. Since the control of the robot R or the like according to the user program is the same as that of conventional robot control devices, a detailed description thereof will be omitted.

The alarm processing unit 16 may be configured to monitor a signal input from the robot R or the like and generate an alarm based on alarm attribute information specified in an alarm call instruction statement described in a user program. That is, the alarm processing unit 16 may be configured to generate an alarm according to an alarm call instruction described in a user program. In other words, it is possible to create a user program that, when an alarm generation condition is detected during execution of the user program, a branch is executed and the alarm call instruction statement is executed without performing normal processing to generate an alarm, thereby alerting the operator and interrupting execution of the program.

The alarm processing unit 16 may be configured to determine a change mode of the program execution state, a display method of the display text, and whether to treat as a system error, according to the alarm severity of the alarm attribute information. The “change mode of the program execution state” means, for example, a type in which the operation of the robot R or the like based on the user program is continued, a type in which the operation of the robot R or the like based on the user program is suspended, or a type in which the execution of the user program is forcibly terminated. The “display method of the display text” means, for example, the size and color of the display text, and the presence or absence of highlighting. In this way, by defining a part of the alarm processing according to the alarm severity, it is possible to suppress the capacity of the alarm attribute information database.

The alarm processing unit 16 may be configured to add related information corresponding to a situation at the time of generation of an alarm to a display text of alarm attribute information, and display the text on a display device of the robot control device 10 or a display device connected to the robot control device 10. The related information added to the display text may be, for example, a character string specifying a device, a component, or the like that issued a signal causing the generation of an alarm. A device or the like causing the generation of an alarm may be specified in advance in an alarm call instruction statement corresponding to a condition setting statement. As an example of implementation, there is a method in which a special character string such as “% s” is embedded in the alarm display text in advance, and at the time of execution of the alarm call instruction, if a “character string to be added to the display text and displayed” is specified, the special character string is replaced with the specified character string and displayed, but the implementation method is not limited thereto.

The alarm processing unit 16 may be configured to execute an alarm generated case processing procedure of the alarm attribute information when an alarm is generated. In addition, the alarm processing unit 16 may be configured to execute an alarm recovered case processing procedure of the alarm attribute information at the time of recovery from the alarm. The alarm generated case processing procedure may be directly described in the alarm attribute information, but is preferably defined in a program describing operations of the robot R or the like, input/output processing, and so on in a language similar to that of the user program, a subroutine in the user program, or the like. The alarm recovered case processing procedure is preferably defined in not only the program describing operations of the robot R or the like and input/output processing as described above, but also in a script or program in which a recovery method peculiar to an alarm is presented and a recovery operation is performed smoothly from the alarm while interacting with the operator in a conversation manner, a subroutine in the user program, or the like. In the alarm attribute information, it is preferable to describe information identifying the program or the like, such as a file name of the program or a start row number of the subroutine. In this way, by specifying the alarm generated case processing procedure and the alarm recovered case processing procedure with the alarm attribute information, it is possible to relatively easily create a user program that performs appropriate processing when an alarm is generated, and it is possible to prevent the capacity of the alarm attribute information database from becoming unnecessarily large.

As described above, since the robot control device 10 includes the database storage unit 12 that stores a database of alarm attribute information that identifies the processing at the time of alarm generation, and the alarm processing unit 16 that generates an alarm based on alarm attribute information specified in an alarm call instruction statement described in a user program, it is possible to generate an alarm that involves complicated processing that cannot be described in a user program, and thus the degree of freedom of the processing at the time of alarm generation is large. Furthermore, according to the robot control device 10, an appropriate user program can be easily created.

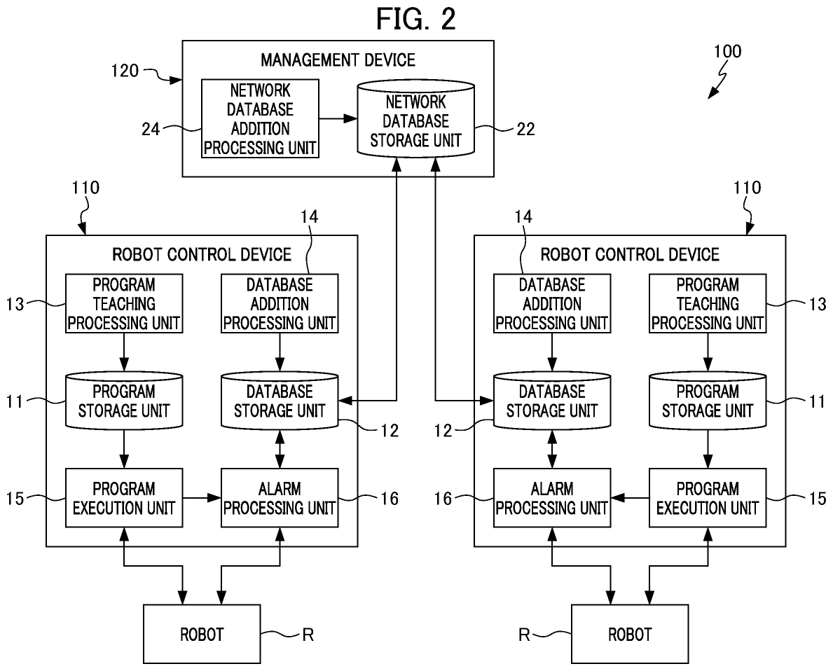

Next, an embodiment of a robot control system according to the present disclosure will be described. FIG. 2 is a block diagram showing a configuration of a robot control system 100 according to a second embodiment of the present disclosure. With regard to the robot control system 100 of FIG. 2, the same components as those of the robot control device 10 of FIG. 1 are denoted by the same reference numerals, and redundant description thereof may be omitted.

The robot control system 100 includes one or more robot control devices 110 each controlling a robot, and a management device 120 that manages the robot control devices 110. The robot control device 110 and the management device 120 communicate with each other via a network or the like. The robot control system 100 may include a plurality of management devices 120. In the robot control system 100, the plurality of management devices 120 may be provided hierarchically to share functions.

The robot control devices 110 shown each include a program storage unit 11, a database storage unit 12, a program teaching processing unit 13, a database addition processing unit 14, a program execution unit 15, and an alarm processing unit 16. The management device 120 includes a network database storage unit 22 and a network database addition processing unit 24. The database storage unit 12 and the database addition processing unit 14 on the robot control device 110 may be omitted. Therefore, in the robot control system 100, the robot control device 110 and the management device 120 cooperate to control the robot R or the like and generate an alarm.

As a specific example, when an alarm is generated in one robot control device 110, the alarm processing unit 16 of the robot control device 110 first searches the network database storage unit 22 for the alarm attribute information of the applicable alarm, and performs alarm processing based on the alarm attribute information if it is found. If the alarm attribute information of the applicable alarm is not found in the network database storage unit 22, the alarm processing unit 16 searches the database storage unit 12 in the robot control unit 110 for the alarm attribute information of the applicable alarm, and performs alarm processing based on the alarm attribute information if it is found. In a case where the alarm attribute information does not exist in either, the system standard alarm processing (e.g., displaying an alarm number to interrupt execution of the user program) is performed.

An advantage of this processing method is that it is possible to perform an operation method in which minimum required standard alarm attribute information is placed on the robot control device 110, and an alarm necessary for an application is additionally stored in the network database storage unit 22 on the management device 120.

In this processing method, in a case where alarm attribute information having a unique key such as the same ID exists on both the robot control device 110 and the management device 120, the alarm attribute information on the management device 120 is preferentially used. This has the advantage that changing the alarm processing method to the standard one can be performed simply by changing the one on the management device 120.

Furthermore, in the robot control system 100, the plurality of robot control devices 110 share the database storage unit 12 and the database addition processing unit 14 provided in the management device 120. With such a configuration, in a factory or the like having a plurality of manufacturing lines, it is not necessary to register an alarm attribute information database in each of the robot control devices 110, so that management is easy.

Although the embodiments of the present disclosure have been described above, the present invention is not limited to the embodiments described above. The effects described in the above-described embodiments are merely examples of the most preferred effects produced by the present invention, and the effects of the present invention are not limited to those described in the above-described embodiments.

In the robot control system, the respective components, i.e., the program storage unit, the database storage unit, the program teaching processing unit, the database addition processing unit, the program execution unit, and the alarm processing unit may be provided in any of the robot control device and the management device. The parts of a component may be distributed between the robot control device and the management device. In a case where the robot control device and the management device are each provided with the database storage unit, either the alarm attribute information stored in the database storage unit of the robot control device or the alarm attribute information stored in the database storage unit of the management device may be prioritized.

### EXPLANATION OF REFERENCE NUMERALS

10, 110 robot control device
11 program storage unit
12 database storage unit
13 program teaching processing unit
14 database addition processing unit
15 program execution unit
16 alarm processing unit
17 database temporary storage unit
22 network database storage unit
24 network database addition processing unit
120 management device
R robot

1. A robot control device for controlling a robot, comprising:
a database storage unit configured to store a plurality of alarm attribute information databases each storing a plurality of pieces of alarm attribute information;
a database addition processing unit configured to add an alarm attribute information database to the database storage unit according to an input by a user; and
an alarm processing unit configured to generate an alarm based on the alarm attribute information.

2. The robot control device according to claim 1, wherein the alarm attribute information includes at least one of display text, alarm severity, alarm generated case processing procedure, or alarm recovered case processing procedure.

3. The robot control device according to claim 2, wherein the alarm attribute information includes a plurality of the display texts corresponding to different languages.

4. The robot control device according to claim 2, wherein the alarm processing unit is configured to determine a change mode of a program execution state, a display method of the display text, and whether to treat as a system error according to the alarm severity.

5. The robot control device according to claim 2, wherein the alarm processing unit is capable of adding related information corresponding to a situation when an alarm is generated to the display text and displaying the display text.

6. The robot control device according to claim 2, wherein the alarm processing unit executes the alarm generated case processing procedure at a time of alarm generation.

7. The robot control device according to claim 2, wherein the alarm processing unit executes the alarm recovered case processing procedure at a time of recovery from an alarm.

8. The robot control device according to claim 1, wherein the alarm processing unit is configured to generate an alarm according to an alarm call instruction included in a user program.

9. A robot control system comprising a robot control device for controlling a robot, and a management device for managing the robot control device, wherein
a database storage unit configured to store a plurality of alarm attribute information databases each storing a plurality of pieces of alarm attribute information,
a database addition processing unit configured to add an alarm attribute information database to the database storage unit according to an input by a user, and
an alarm processing unit configured to generate an alarm based on the alarm attribute information
are each provided in at least one of the robot control device or the management device.

10. The robot control system according to claim 9,
wherein the database storage unit is provided in each of the robot control device and the management device, and
wherein the alarm processing unit first searches the database storage unit of the management device, and in a case where applicable alarm attribute information is not found, searches the database storage unit of the robot control device.
